(19) United States
(12) Patent Application Publication
(10) Pub. No.: US 2017/0140184 A1
(43) Pub. Date: May 18, 2017

(54) System and Method for Tracking an Agricultural Asset Transferred Among Plural Asset Receiving Devices

(71) Applicant: IntraGrain Technologies Inc., Regina (CA)

(72) Inventor: Kyle Ronald Folk, Regina (CA)

(21) Appl. No.: 15/341,402

(22) Filed: Nov. 2, 2016

Related U.S. Application Data
(60) Provisional application No. 62/254,777, filed on Nov. 13, 2015.

(51) Int. Cl. G06K 7/10

(52) U.S. Cl. CPC G06K 7/10366; H04W 84/042

(57) ABSTRACT

A tracking system is capable of tracking a history of an agricultural asset transferred among a plurality of asset receiving devices using a communications network. The system uses radio-frequency identification tags intermixed with the agricultural asset. A main server, in communication with the network, stores the tag identification of each tag therein. A controller associated with each asset receiving device includes a controller identification, a receiving component for receiving the identification of the tags within the respective asset receiving device, and a transmitting component for transmitting the tag identifications to the main server together with the controller identification. The main server stores a historical record in association with each tag identification that primarily consists of the controller identification of each controller which has transmitted the tag identification to the main server with the respective controller identification associated therewith.

This application is claims the benefit under 35 U.S.C. 119(e) of U.S. provisional application Ser. No. 62/254,777, filed Nov. 13, 2015.

### FIELD OF THE INVENTION

The present invention relates to a system and method using radio-frequency identification (RFID) tags which are intermixed with an agricultural assets, for example grain, for tracking the asset as it is transferred among different asset receiving devices, for example a grain bin, a transport truck, an elevator, a railcar, etc., by transmitting the tag identification from each different asset receiving device over a communications network, for example the internet, to a central server which stores a historical record for each tag. Furthermore, the present invention relates to a method and system for tracking the asset in which sensors record environmental conditions, for example moisture and temperature, for storage in the historical record together with an identification of each asset receiving device.

### BACKGROUND

Agricultural assets, and more particularly grain, are typically transferred among many different handling, storage and transport equipment from the time it is initially harvested until it reaches a final processing destination. For example, grain is typically initially transported from harvesting equipment such as a combine to a local storage bin using a truck and the like. Typically after being stored for some time, the grain may be again transferred to a truck for transport to an elevator where the grain is mixed with grain from other sources in a silo before being subsequently transferred to railcars. The railcars may then transport the grain directly to a processing facility, or containers receiving the grain therein may be transferred to other transport equipment including trucks or boat for shipment to other processing facilities. Although it is known to be desirable to ascertain the origin of the grain once it reaches its final destination, in view of the many different asset receiving devices across which numerous different batches of grain are transferred and intermixed, it is a difficult task to accurately record the origin of any selected batch of grain ultimately delivered to a final processing destination.

U.S. Pat. Nos. 7,047,103, 7,162,328 and 7,511,618 all by Hornbaker et al, and US Patent Application Publication No. 2013/0184859 by Sell disclose various systems and methods for tracking grain using radio-frequency identification tags. The tags are provided with a memory onto which the identification of various grain handling equipment is written as the tags are transferred with the grain across the different handling equipment. Accessing the data requires accessing the memory on the tags themselves in a limiting manner.

U.S. Pat. No. 7,062,513 and US Patent Application Publication no. 2004/0015477, both by Deere & Company, disclose methods and systems for tracing an identity of an agricultural product by associating a container identification with a shipping container that is transferred among a plurality of container handling devices. A product flow is established by the system which is comprised of the container identification together with the identification of each corresponding handling device associated therewith. U.S. Pat. No. 7,062,513 relies on transferring container identification data from one handling device to the next, such that the integrity of the data at the final destination relies on proper function of each device in the handling chain. In contrast, US 2004/0015477 communicates the container identification and the corresponding handling device identification over a network such as the internet to a main server at each handling location. In both systems, the tracking is limited to containers and no means are provided to trace product transferred between different types of containers and which is mixed with product from other sources as it is transferred.

### SUMMARY OF THE INVENTION

According to one aspect of the invention there is provided a tracking system for tracking a history of an agricultural asset transferred among a plurality of asset receiving devices using a communications network, the system comprising:

a plurality of radio-frequency identification tags arranged to be intermixed with the agricultural asset, each having a respective tag identification;

a main server having a memory storing the tag identification of each tag therein and a communication interface arranged to communicate with the communications network; and

a controller associated with each asset receiving device, each controller comprising:
a controller identification;
a receiving component arranged to communicate with any of the tags within the respective asset receiving device to receive the respective tag identifications thereof; and
a transmitting component arranged to communicate with the communications network so as to transmit any of the tag identifications received from the respective receiving component to the main server together with the respective controller identification;

the main server being arranged to store a historical record in association with each tag identification comprised of the controller identification of each controller which has transmitted the tag identification to the main server with the respective controller identification associated therewith.

According to a second aspect of the present invention there is provided a method of tracking a history of an agricultural asset transferred among a plurality of asset receiving devices using a communications network, the method comprising:

providing a plurality of radio-frequency identification tags arranged to be intermixed with the agricultural asset, each tag having a respective tag identification;

providing a main server having a memory storing the tag identification of each tag therein and a communication interface arranged to communicate with the communications network;

providing a controller associated with each asset receiving device which includes a controller identification;

using each controller to communicate with any of the tags within the respective asset receiving device to receive the respective tag identifications thereof and to communicate with the communications network so as to transmit any of the received tag identifications to the main server together with the respective controller identification; and

storing on the main server a historical record in association with each tag identification comprised of the controller identification of each controller which has transmitted the tag identification to the main server with the respective controller identification associated therewith.

The system and method described herein, permit batches of grain surrounding each tag to be tracked as the grain is handled across a plurality of different equipment, even when the grain is split into different smaller batches or amalgamated together into larger batches. Furthermore, by communicating to a central server at each handling location, an accurate historical record can still be maintained even when there is a communication failure of any one individual controller of the overall system.

Preferably a plurality of condition sensors are arranged to sense at least one environmental storage condition corresponding to a storage environment of the agricultural asset within one of the asset receiving devices. In this instance the transmitting components of the controllers being arranged to transmit said at least one environmental storage condition in association with the corresponding tag identifications and the main server is arranged to store said at least one environmental storage condition in the historical record associated with the corresponding tag identifications. For example, the environmental condition sensed by the condition sensors may be a moisture content, a temperature, a concentration of a prescribed gas, etc.

The use of condition sensors together with the tracking system described above permits the resulting historical record to identify both the different locations that each batch of grain has passed through, as well as the storage conditions at each location. This provides the final destination processor with both origin information as well as storage conditions throughout the history of the handling of the product from harvesting to processing to provide some assurances as to the quality of the product being received.

In some embodiments, each tag may integrally support a respective one of the condition sensors thereon. In this instance, the receiving component of each controller is arranged to communicate with the tags so as to receive the tag identifications and said at least one environmental storage condition of the respective condition sensor associated therewith.

Alternatively, the condition sensors may be arranged to be supported on the asset receiving devices in communication with the agricultural asset independently of the tags. For example, each receiver component may include a supporting body such as a flexible cable arranged to be suspended within an asset containment area of the respective asset receiving device in which the condition sensors are arranged to be supported on the supporting body of the receiver component of the respective controller.

Each controller may be arranged to periodically sample the sensed environmental storage condition from the condition sensors, and transmit one or both of the sensed environmental storage condition and/or the associated tag identifications to the main server only if the sensed environmental storage condition has changed relative to a previous sampling.

In some embodiments, each receiver component includes a supporting body arranged to be suspended within an asset containment area of the respective asset receiving device. In this instance, the supporting body may comprise a flexible cable arranged to be suspended substantially vertically within the asset containment area of the respective asset receiving device.

The transmitter component of each controller is preferably arranged to communicate directly with the communications network.

The system may further include a local network device arranged to communicate with the communications network, in which the transmitting component of some of the controllers are arranged to communicate with the communications network through the local network device.

Preferably each radio-frequency identification tag has a unique tag identification.

According to another important independent aspect of the present invention there is provided a collection device arranged to reclaim the radio-frequency identification tags from the agricultural asset which can be used with the system. Preferably the collection device including a receiving component arranged to communicate with any of the tags collected by the collection device and a transmitter component arranged to communicate with the communications network so as to transmit the tag identifications of collected tags to the main server. In this instance, the main server may be arranged to close the existing historical record and store a new historical record for each tag identification received from the collection device.

In some embodiments, the transmitter component of each controller comprises a cellular transceiver arranged to communicate with the main server over a cellular network in which each cellular transceiver has an integrated circuit card identifier and an international mobile subscriber identity in which the integrated circuit card identifier of each transceiver is unique and the international mobile subscriber identity of at least two transceivers are identical to one another.

Some embodiments of the invention will now be described in conjunction with the accompanying drawings in which:

### BRIEF DESCRIPTION OF THE DRAWINGS

FIG. 1 is a schematic representation of the tracking system illustrating a plurality of asset receiving devices communicating with the main server over a communications network; and

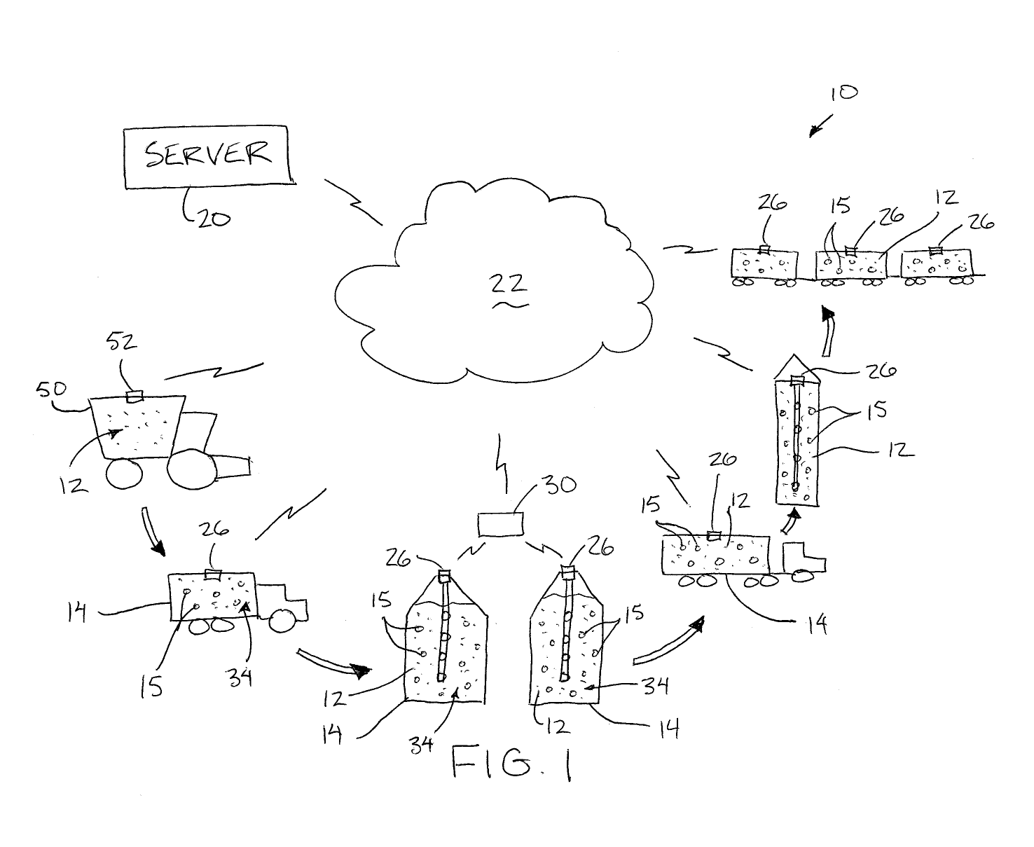

FIG. 2 is a schematic representation of the communication between the RFID tags and the controller associated with one asset receiving device.

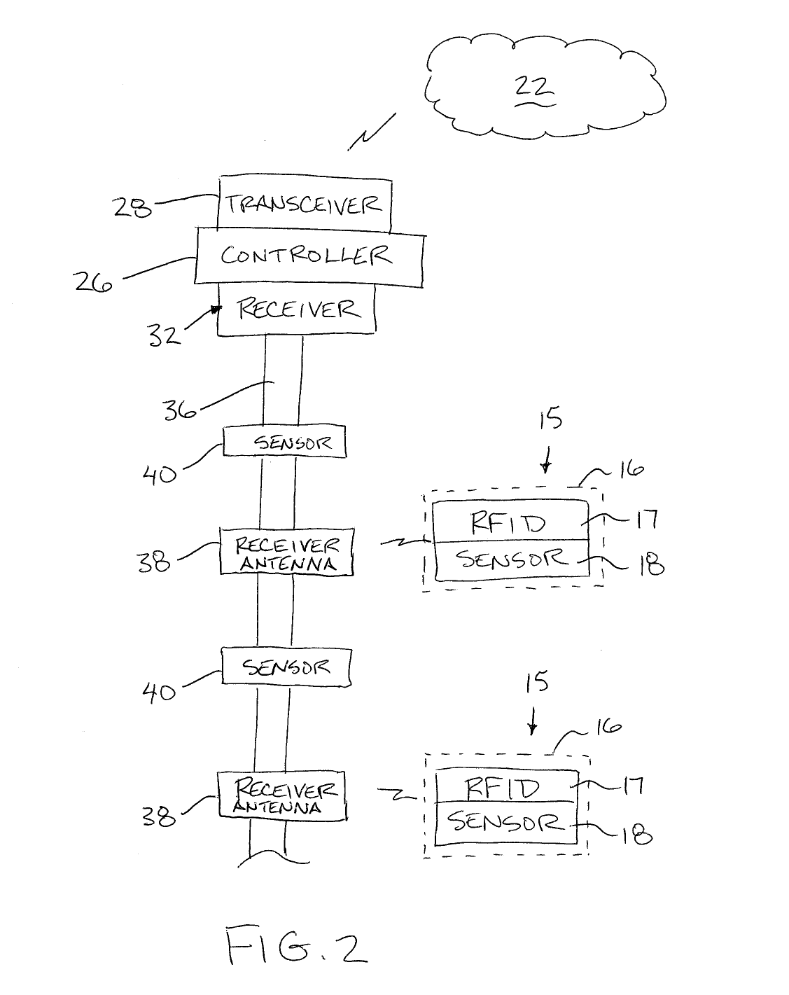

In the drawings like characters of reference indicate corresponding parts in the different figures.

### DETAILED DESCRIPTION

Referring to the accompanying figures, there is illustrated an agricultural asset tracking system generally indicated by reference numeral 10. The system 10 is suitable for tracking assets 12, for example grain and the like, as it is transferred between numerous asset receiving devices 14, for example combines, farm trucks, storage bins, highway transport trucks, elevators, rail cars and the like.

The system 10 employs a plurality of radio frequency identification tags 15. Each tag comprises a housing 16 which is sized and has a suitable weight such that the overall density enables the tags to be substantially evenly intermixed with the asset. Within the housing there is provided RFID components 17 including a memory storing a unique tag identification therein and an antenna to enable the tag to transfer data by wireless non-contact use of radio frequency electromagnetic fields.

The tags are intended to be powered by and read at short ranges via electromagnetic induction. The tags in the preferred embodiment collect energy from an interrogating electromagnetic field so as to act as a passive transponder to emit microwaves or other electromagnetic radiation at high frequencies.

In the illustrated embodiment, each housing 16 also include a condition sensor 18 in addition to the RFID components 17. The condition sensor 18 is arranged to sense an environmental storage condition surrounding the tag, for example surrounding temperature, moisture content, or the presence of carbon dioxide for example. The sensor is arranged to be powered similarly to the RFID components.

The system 10 further comprises a main central server 20 which may comprise a single computer or a plurality of network computers distributed across one or more locations, but which collectively provide the functions described in the following. The central server 20 includes a memory arranged to store programming for executing the various functions of the system. The memory is used to store a historical record in association with each unique tag identification belonging to the various tags described above. The main central server 20 further includes a communication interface which is arranged to communicate with a suitable communications network 22. The communications network 22 may comprise the internet, a local network, a cellular network, or any combinations thereof.

The system 10 further includes a controller 26 associated with each one of the asset receiving devices 14. The controller includes a transmitting component in the form of a transceiver 28 which is arranged to communicate with the communications network 22 to both transmit data to the main central server 20 over the network or receive data therefrom. For example, the transceiver may comprise a cellular transceiver communicating with a cellular network which in turn interfaces with the internet to the main central server 20. In some instances, the controllers 26 communicate directly with the communications network, however in other instances, groups of controllers 26 may include transceivers 28 arranged to communicate over a local network to a master controller 30 such that the master controller includes the cellular transceiver for communicating over a cellular network to the internet and in turn to the main central server 20.

In each instance, the controller 26 further includes a receiver component 32. When the asset receiving device includes a large containment area 34, the receiver component may include a support body in the form of an elongate flexible cable 36 arranged to be suspended substantially vertically within the containment area 34. The support body includes receiver antennas 38 at longitudinally spaced positions along the cable which are suitable to communicate with the RFID components of the tags 15. More particularly, each receiver antenna 38 is arranged to both deliver power to the tags by electromagnetic induction as well as read data from the tags. The data read from the tags can include both the unique tag identification and any sensed conditions in association therewith.

In the illustrated embodiment, the receiver 32 further includes a plurality of sensors 40 at longitudinally spaced positions along the support cable 36 suspended within the containment area of the asset receiving device. The sensors 40 comprise additional condition sensors arranged to sense surrounding environmental conditions, for example temperature, moisture content, or carbon dioxide content.

Each controller 26 includes a respective memory which stores a unique controller ID thereon corresponding to a unique identification of the associated asset receiving device 14. The memory also stores suitable programming thereon to execute the various functions described herein. Specifically, the controller functions to regularly sample the tags 15 and the sensors 40 of the receiver at prescribed periodic intervals for recording tag identifications and associating sensed conditions from the sensors 18 on the tags and/or the sensors 40 on the receiver support body in association with the tag identifications.

At each sampling of the data, the controller compares the sample data to a previous data sampling. If the identifications of the relevant tags remains unchanged and the conditions sensed by the sensors 18 and 40 remain unchanged, the controller need not take any further action. However, if any change is determined which is greater than the prescribed condition threshold or if the identifications of any tags associated with any one controller change, then the controller initiates reporting to the main server. Specifically, the controller sends a data packet to the main central server comprises of the controller identification in association with all of the tag identifications associated therewith, and in further association with any sensed conditions by the sensors 18 or 40. Upon successfully communicating the data to the server, the connection to the server is terminated until the next periodic sampling and reporting period.

Typically, a counter is provided at the controller level such that the controller will still report the relevant tag identifications and sensed conditions even if they remain unchanged if a prescribed number of cycles have passed without any reporting to the main central server.

In the instance of a master controller 30 operating a local network of a group of controllers 26, the master controller may include the programming to initiate sampling from the groups secondary controllers 26 with the master controller storing the previous sampling data thereon for comparison in determining if reporting to the main server is required.

The main server functions to record all of the data received from the various controllers 26 and store the data in respective historical records associated with each of the tag identifications respectively. The historical record comprises a time line indicating the location of the RFID tag by the last reported controller identification and with environmental conditions at various time intervals being determined by the last known reported sensed conditions by the sensors 18 and 40. All received data at the main server is added to the historical record as the conditions change or as the location changes in view of a different controller identification being associated with the tag identification.

At a final destination of the product with the tags intermixed therein, a collection device is provided to reclaim the tags from the agricultural assets. The collection device is typically arranged to mechanically separate the tags from the grain, for example by filtering or other suitable means. The collected tags are cleaned and are read by a suitable receiver of the collection device.

The collection device includes a controller substantially like the controllers 26 described above which stores a respective controller identification in the memory thereof and which includes a suitable receiver component arranged to communicate with the tags to record the tag identifications thereof. The controller of the collection device reports the tag identifications in association with the identification of the collection device over the network to the main server. In response, the main server closes the existing historical record associated with the tag identification so that no further data is attached to that historical record and it is stored as a permanent record in the system. The system then reassigns the tag identification to a new historical record such that any further reporting involving that tag identification appends data to the new historical record separate from the closed record previously associated with that tag identification.

In use, the system 10 may be used to track the entire history of a product, for example grain, from harvest to delivery to a processor. Harvesting equipment such as a combine 50 may include a respective controller 52 having a respective controller identification stored therein similarly to the controllers 26 noted above. The controller associates the combine identification with other appended data including GPS information indicating a field of origin and the like. The controller includes a suitable transmitter component as described above to report to the main server. The proximity of the combine to subsequent handling equipment including transport trucks or an initial storage bin where tags are initially added can be used to associate the combine identification with the tag identifications to start the tracking and initiate the historical record for each tag. The tags can be added to the harvested grain that any device including a containment area receiving the grain therein. The tags are also suitable for being added to transfer equipment such as conveyors and the like to more evenly distribute the tags among the product.

Once the tags are added to the product, each subsequent asset receiving device 14 includes a controller 26 including a receiver to record the identifications of the tags as well as sensed conditions by the sensors 18 and 40 for transmitting the collected data over the network to the main central server. By this means, the server starts a historical record for each tag identification and associates environmental conditions of the first containment area of the device 14 where the tags are first received together with the identification of any combine 50 associated by proximity to the first device 14 receiving the tags therein. Each of the asset receiving devices 14 within the product flow chain from harvesting through to delivery to an end processor is provided with a controller 26 which continues to periodically sample the tag identifications and associated sensed conditions to continue to periodically report to the main server.

By reporting individual tag identifications which are intermixed with the grain throughout the process, and by associating the incoming data into historical records specific to each tag identification, a historical record can be readily achieved for corresponding units of grain, even as the units are intermixed into larger batches or split-up into smaller batches throughout the product flow chain. The resulting record includes not only a detailed listing of the history of different portions of the grain within a final batch, but also provides an indication of the quality thereof by reporting the storage conditions at each stage of the process.

In view of the large number of controllers 26 which may be required, the transceivers of the controllers may be arranged to comprise cellular transceivers each having an integrated circuit card identifier and an international mobile subscriber identity in which the integrated circuit card identifier remains unique among the transceivers but the international mobile subscriber identity of numerous transceivers are identical to one another. As the reporting by the controllers to the main server occurs only in small batches, many of the controllers can effectively share a common phone number. Even in the instance where the main server wishes to initiate contact with the controllers to update the software or make queries of various kinds for example the controllers may be arranged to receive the data collectively or the integrated circuit card identifier can be used subsequent to an established connection to determine if the communication is intended for that particular controller.

The server 20 may be further provided with a user interface such as a web login presented over the internet to which individual users can connect from their own terminals communicating over the network. The individual users are permitted to login and (subsequent to suitable authentication by the server) can access the relevant data associated with the tag identifications used by that user.

Since various modifications can be made in my invention as herein above described, it is intended that all matter contained in the accompanying specification shall be interpreted as illustrative only and not in a limiting sense.

1. A tracking system for tracking a history of an agricultural asset transferred among a plurality of asset receiving devices using a communications network, the system comprising:
a plurality of radio-frequency identification tags arranged to be intermixed with the agricultural asset, each having a respective tag identification;
a main server having a memory storing the tag identification of each tag therein and a communication interface arranged to communicate with the communications network; and
a controller associated with each asset receiving device, each controller comprising:
a controller identification;
a receiving component arranged to communicate with any of the tags within the respective asset receiving device to receive the respective tag identifications thereof; and
a transmitting component arranged to communicate with the communications network so as to transmit any of the tag identifications received from the respective receiving component to the main server together with the respective controller identification;
the main server being arranged to store a historical record in association with each tag identification comprised of the controller identification of each controller which has transmitted the tag identification to the main server with the respective controller identification associated therewith.

2. The system according to claim 1 further comprising a plurality of condition sensors arranged to sense at least one environmental storage condition corresponding to a storage environment of the agricultural asset within one of the asset receiving devices, the transmitting components of the controllers being arranged to transmit said at least one environmental storage condition in association with the corresponding tag identifications, and the main server being arranged to store said at least one environmental storage condition in the historical record associated with the corresponding tag identifications.

3. The system according to claim 2 wherein each tag integrally supports a respective one of the condition sensors thereon, the receiving component of each controller being arranged to communicate with the tags so as to receive the tag identifications and said at least one environmental storage condition of the respective condition sensor associated therewith.

4. The system according to claim 2 wherein the condition sensors are arranged to be supported on the asset receiving devices in communication with the agricultural asset independently of the tags.

5. The system according to claim 4 wherein each receiver component includes a supporting body arranged to be supported within an asset containment area of the respective asset receiving device and wherein the condition sensors are arranged to be supported on the supporting body of the receiver component of the respective controller.

6. The system according to claim 2 wherein said at least one environmental condition sensed by the condition sensors comprises a moisture content.

7. The system according to claim 2 wherein said at least one environmental condition sensed by the condition sensors comprises a temperature.

8. The system according to claim 2 wherein each controller is arranged to periodically sample the sensed environmental storage condition from the condition sensors, and transmit the sensed environmental storage condition to the main server only if the sensed environmental storage condition has changed relative to a previous sampling.

9. The system according to claim 1 wherein each controller is arranged to periodically sample which tag identifications are associated therein and to transmit the associated tag identifications to the main server only if the associated tag identifications have changed relative to a previous sampling.

10. The system according to claim 1 wherein each receiver component includes a supporting body arranged to be suspended within an asset containment area of the respective asset receiving device.

11. The system according to claim 10 wherein the supporting body comprises a flexible cable arranged to be suspended substantially vertically within the asset containment area of the respective asset receiving device.

12. The system according to claim 1 wherein the transmitter component of each controller is arranged to communicate directly with the communications network.

13. The system according to claim 1 further comprising a local network device arranged to communicate with the communications network, wherein the transmitting component of some of the controllers are arranged to communicate with the communications network through the local network device.

14. The system according to claim 1 wherein each radio-frequency identification tag has a unique tag identification.

15. The system according to claim 1 further comprising:
a collection device arranged to reclaim the radio-frequency identification tags from the agricultural asset;
the collection device including a receiving component arranged to communicate with any of the tags collected by the collection device and a transmitter component arranged to communicate with the communications network so as to transmit the tag identifications of collected tags to the main server; and
the main server being arranged to close the existing historical record and store a new historical record for each tag identification received from the collection device.

16. The device according to claim 1 wherein the transmitter component of each controller comprises a cellular transceiver arranged to communicate with the main server over a cellular network, each cellular transceiver having an integrated circuit card identifier and an international mobile subscriber identity in which the integrated circuit card identifier of each transceiver is unique and the international mobile subscriber identity of at least two transceivers are identical to one another.

17. A method of tracking a history of an agricultural asset transferred among a plurality of asset receiving devices using a communications network, the method comprising:
providing a plurality of radio-frequency identification tags arranged to be intermixed with the agricultural asset, each tag having a respective tag identification;
providing a main server having a memory storing the tag identification of each tag therein and a communication interface arranged to communicate with the communications network;
providing a controller associated with each asset receiving device which includes a controller identification;
using each controller to communicate with any of the tags within the respective asset receiving device to receive the respective tag identifications thereof and to communicate with the communications network so as to transmit any of the received tag identifications to the main server together with the respective controller identification; and
storing on the main server a historical record in association with each tag identification comprised of the controller identification of each controller which has transmitted the tag identification to the main server with the respective controller identification associated therewith.
